(19) United States
(12) Patent Application Publication
(10) Pub. No.: US 2014/0158730 A1
(43) Pub. Date: Jun. 12, 2014

(54) Firearm Holster For Secure Storage And Easy Access In A Vehicle

(71) Applicant: James McDonnell, St. Louis, MO (US)

(72) Inventor: James McDonnell, St. Louis, MO (US)

(21) Appl. No.: 13/709,736

(22) Filed: Dec. 10, 2012

(51) Int. Cl. B60R 7/14

(52) U.S. Cl. CPC B60R 7/14
USPC 224/539

(57) ABSTRACT

A firearm holster for storing a firearm within a vehicle such that the firearm is secure and easily accessible. The holster includes a backing panel and a firearm housing connected to the backing panel and structured and operable to provide a firearm receptacle to removably retain a firearm. The holster additionally includes a support panel connectable to the backing panel. The support panel structured and operable to be positioned and secured, along with the backing panel and firearm receptacle, between two closely adjacent structures of the vehicle and to contact a floor of the vehicle along a bottom edge such that the firearm receptacle is positionable at a desired height above the floor between the closely adjacent structures. The holster further includes a cinching strap connected to the backing panel. The cinching strap structured and operable to secure the holster to an anchor point within the vehicle.

### FIELD

The present teachings relate to firearms, and more particularly to holsters for firearms that allow the firearm to be securely stored and easily accessible within a vehicle.

### BACKGROUND

The statements in this section merely provide background information related to the present disclosure and may not constitute prior art.

Often firearm owners wish to transport, or carry, their firearm with them when they are traveling in a vehicle, such as a car or truck. In such instances, the firearm owner will store the fire arm in the glove box of the vehicle where the firearm is subject being jostled around inside the glove box due to movement of the vehicle. Additionally, the firearm is not readily accessible when stored in the glove box. Alternatively, owners will often place the firearm on the floor of the vehicle, e.g., under their seat. However, storage on the floor also limits easy access and subjects the firearm to being jostled around due to movement of the vehicle.

### SUMMARY

The present disclosure provides a firearm holster for storing a firearm within a vehicle such that the firearm is secure and easily accessible. In various embodiments, the holster includes a backing panel and a firearm housing connected to the backing panel and structured and operable to provide a firearm receptacle to removably retain a firearm. The holster additionally includes a support panel connectable to the backing panel. The support panel structured and operable to be positioned and secured, along with the backing panel and firearm receptacle, between two closely adjacent structures of the vehicle and to contact a floor of the vehicle along a bottom edge such that the firearm receptacle is positionable at a desired height above the floor between the closely adjacent structures. The holster further includes a cinching strap connected to the backing panel. The cinching strap structured and operable to secure the holster to an anchor point within the vehicle.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an illustration of a person wearing a concealed-carry holster having concealing belt clip covers disposed over belt clips of the holster, in accordance with various embodiments of the present disclosure.

FIG. 2 front view of the concealed-carry holster shown in FIG. 1, in accordance with various embodiments of the present disclosure.

FIG. 2A is front view of the concealed-carry holster shown in FIG. 1, in accordance with various other embodiments of the present disclosure.

FIG. 3A is an illustration of a belt clip of the concealed-carry holster shown in FIG. 1, in accordance with various embodiments of the present disclosure.

FIG. 3b is an illustration of a belt clip cover of the concealed-carry holster shown in FIG. 1, in accordance with various embodiments of the present disclosure.

FIG. 4 is a block illustration of a rear view of the front seats of an automobile having disposed between a driver's seat and a center console a concealed-carry holster, in accordance with various embodiments of the present disclosure.

FIG. 5 is front view of the concealed-carry holster shown in FIG. 4, in accordance with various embodiments.

FIG. 6 is front view of the concealed-carry holster shown in FIG. 4 including a cover flap, in accordance with various embodiments.

Corresponding reference numbers indicate corresponding parts throughout the several views of drawings.

### DETAILED DESCRIPTION

The following description is merely exemplary in nature and is in no way intended to limit the present teachings, application, or uses. Throughout this specification, like reference numbers will be used to refer to like elements.

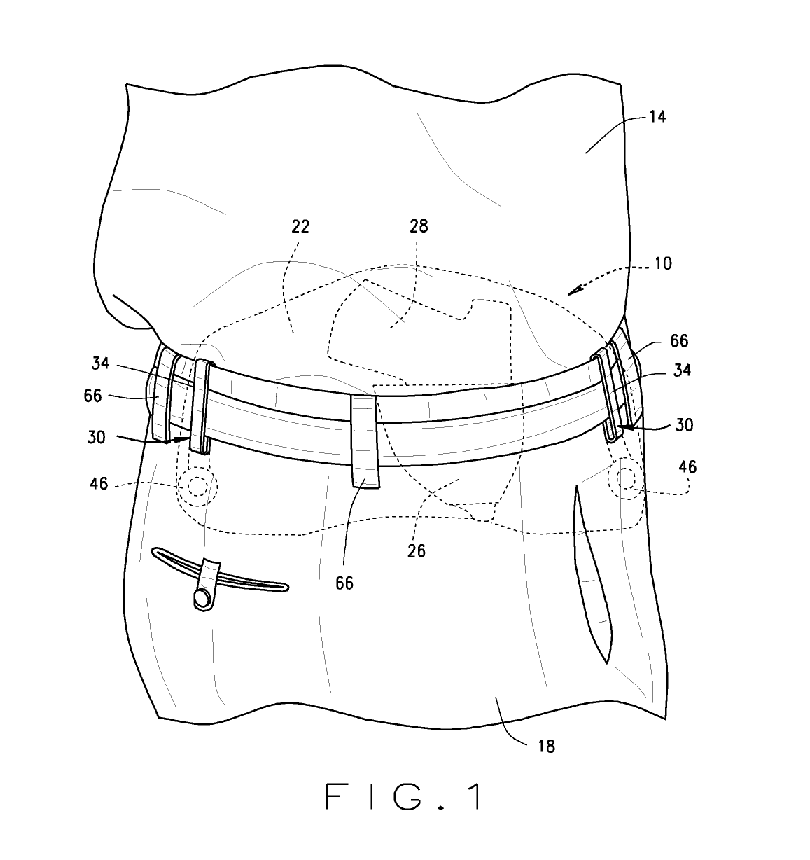

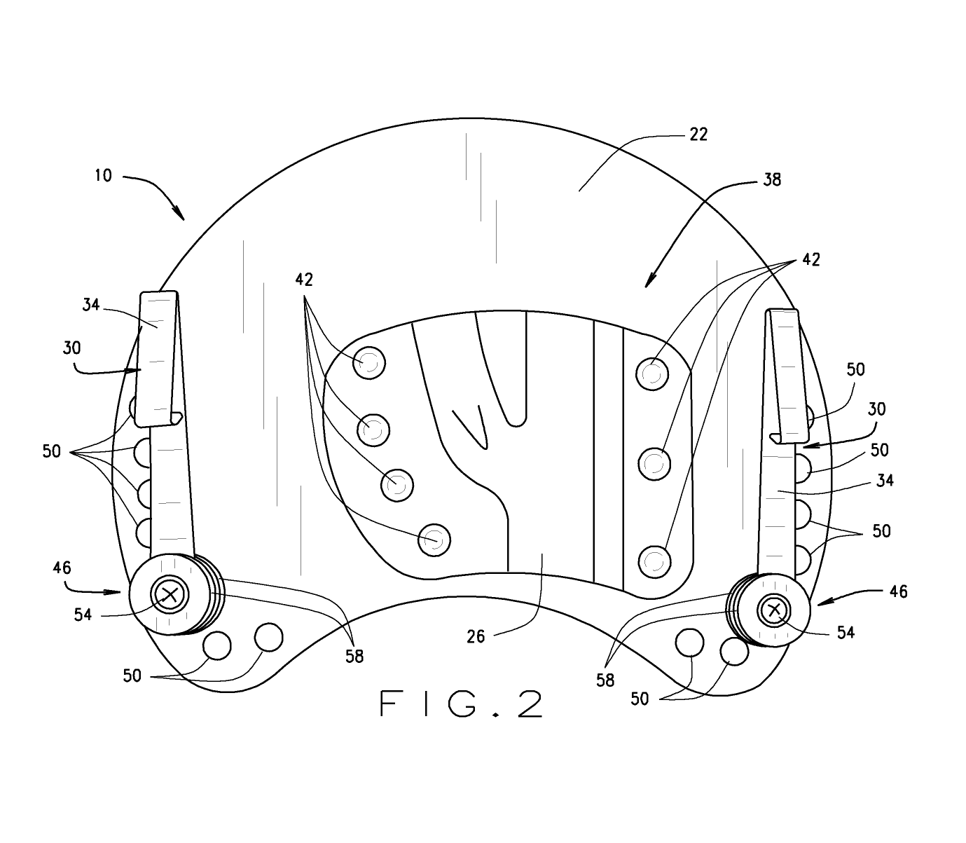

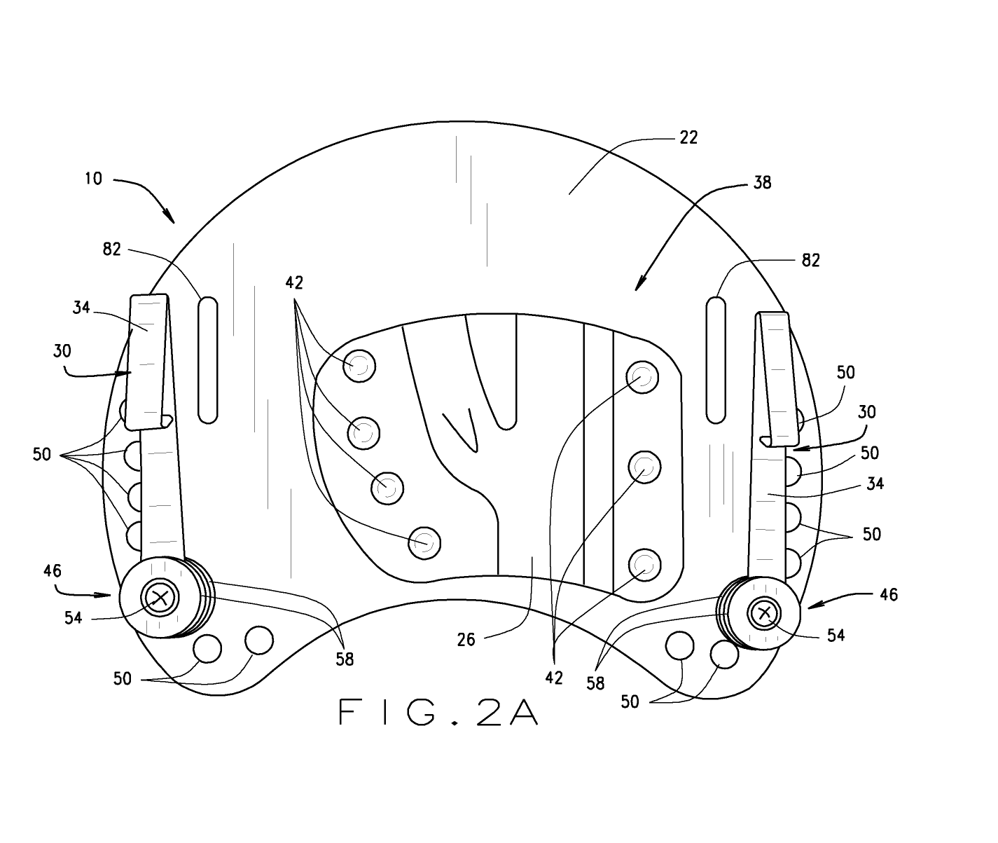

Referring to FIGS. 1 and 2, the present disclosure provides a concealed-carry firearm holster 10 for wearing under the clothes of a user, e.g., under a shirt 14 and pants 18 of the user, between the user's waist and a waistband of the user's pants 18. As used herein, the user's waist will be understood to mean any portion of the user's body around his/her waist, e.g., the user's hip, the flat or tail of the user's back, or the user's abdomen. Hence, although the holster 10 is exemplarily illustrated in FIG. 1 as being positioned on the user's hip, the disclosure should not be so limited. The holster 10 generally includes a backing panel 22, a firearm housing 26 mounted to the backing panel 22, at least a pair of belt clips 30 removably connected to the backing panel 22, and a plurality of belt clip covers 34 disposed over each of the belt clips 30 and structured to resemble belt loops 66 of the user's pants 18.

The firearm housing 26 is mounted to the backing panel 22 such that the backing panel 22 provides a back side of a firearm receptacle 38 formed between the firearm housing 26 and the backing panel 22. The receptacle 38 is structured and operable to securely, but removably retain a firearm 28, e.g., a pistol. The housing 26 is connected to the backing panel 22 by a plurality of connectors 42 that can be any connecting device suitable to either fixedly or removably connect the housing 26 to the backing panel 22, e.g. screws, rivets, stitching, glue, snaps, etc. The backing panel 22 is constructed of a flexible and durable material, such as leather, and is structured and operable to be placed against the user's body and to shield the user's body from injury or irritation when inserting and withdrawing the firearm 28 into and from the receptacle 26.

Referring now to FIGS. 1, 2 and 3A, the belt clips 30 are removably connected to the backing panel 22, via removable clip fasteners 46. More particularly, the backing panel 22 includes a plurality of mounting holes 50 disposed along opposing edges, as exemplarily illustrated in FIG. 2. The mounting holes 50 are structured and operable to receive the clip fasteners 46 such that the belt clips 30 can be connected to the backing panel 22 in a variety of locations along the backing panel edges. Therefore, the belt clips 30 can be connected to the backing panel 22 in order to selectively position and orient the firearm receptacle 38, i.e., the firearm housing 26. That is, when the holster 10 is worn by the user, the firearm receptacle 38 can be positioned at a desired height, relative to the top of the user pants 18, and in a desired orientation, i.e., rotated forward or backward, so that the firearm 28 retained within the firearm receptacle 38 will be positioned and oriented at a selected height and angle as desired by the user.

The clip fasteners 46 can be any fastening device that can be installed, via the selected mounting holes 50, to securely fasten the belt clips 30 to the backing panel 22, and be removed to allow the belts clips to be detached from the backing panel 22 and be removed or moved to a different location on the backing panel 22, via the mounting holes 50. For example, in various embodiments, the clip fasteners 46 can comprise a screw 54 that is threadably engageable with a threaded disk (not shown), and a pair of washers 58, e.g., leather washers. In such embodiments, the proximal end 62 of each belt clip 30 is sandwiched between a respective pair of washers 58 and positioned on the front of the backing panel 22 such that apertures (not shown) of the washers 58 align with selected mounting holes 50. Subsequently, the threaded disks are positioned on the back of the backing panel 22 adjacent the selected mounting holes 50. The screws 54 are then inserted through the washer apertures and the selected mounting holes 50 and threadingly engaged with the respective threaded disks. The screws 54 are then tightened to secure the belt clips 30 to the backing panel 22.

The belt clips 30 are structured and operable to removably secure the holster 10 to the waistband of the user's pants 18, or more likely to the waistband and a belt threaded through belt loops 54 of the user's pants 18, to retain the holster 10 in position under the user's shirt 14 and pants 18. In various embodiments, each belt clip 30 comprises a wire frame 70 having two opposing side rails 70A and 70B. The side rails 70A and 70B are structured have a shape such that they extend upwardly from the clip fasteners 46, along the inside of the users pants and out the top of the waistband, then bend downwardly over the waistband, or waistband and belt if desired, and then bend back, at a distal end 74, toward the user and upwardly such that the distal end 74 can hook under the user's belt if desired. Importantly, the portion of the wire frame that bends down over the waistband, or waistband and belt if desired, is sized and shape to resemble the size and shape of the belt loops of the user's pants.

Additionally, in various embodiments, proximal ends 62A and 62B of the opposing rails 70A and 70B are bent or curled to fashion a hook or a loop that will wrap at least partially around a portion of the respective fastener 46, e.g., around the threaded shaft of a screw, to securely retain the belt clips 30 on the backing panel 22 when the fasteners 46 are tightened to connect the belt clips 30 to backing panel 22. More particularly, the hooks and/or loops at the proximal ends 62A and 62B provide a larger base and more surface area of the side rails 70A and 70B that can be held by the respective clip fasteners 46, e.g., a larger base and more surface area can be clamped between the screws 45 washers 58 and threaded disks, such that the belt clips 30 will be stably connected to the backing panel 22 and will not readily twist or turn longitudinally.

Referring now to FIGS. 1, 2, 3A and 3B, as described above, each of the belt clips 30 of the holster 10 is covered with a respective belt clip cover 34 that is structured and designed to resemble the belt loops 66 of the user's pants 18. More specifically, as described above, each wire frame 70 is structured to have a size and shape substantially similar to the belt loops 66, and each belt clip cover 34 is fabricated to closely resemble the fabric, material and/or design of the belt loops 66 of the user's pants 18 such that when the holster 10 is worn by the user, i.e., clipped to the user's pants, and belt if desired, the belt clips 30 covered with the belt clip covers 34 will substantially match the size, shape and color of belt loops 66 of the user's pants. Therefore, when the holster 10 is attached the user's pants, and belt if desired, and the user's shirt 14 is positioned to cover the holster 10 and firearm 28 and is tuck into the user's pants 18 to conceal the holster 10 and firearm 28, the belt clips 30 will appear to be additional belt loops 66, such it will be generally unnoticed that the user is wearing the holster 10. That is, the belt clips 30 will be camouflaged, so to speak, by the covers 34 to simply appear as belt loops 66 of the pants 18.

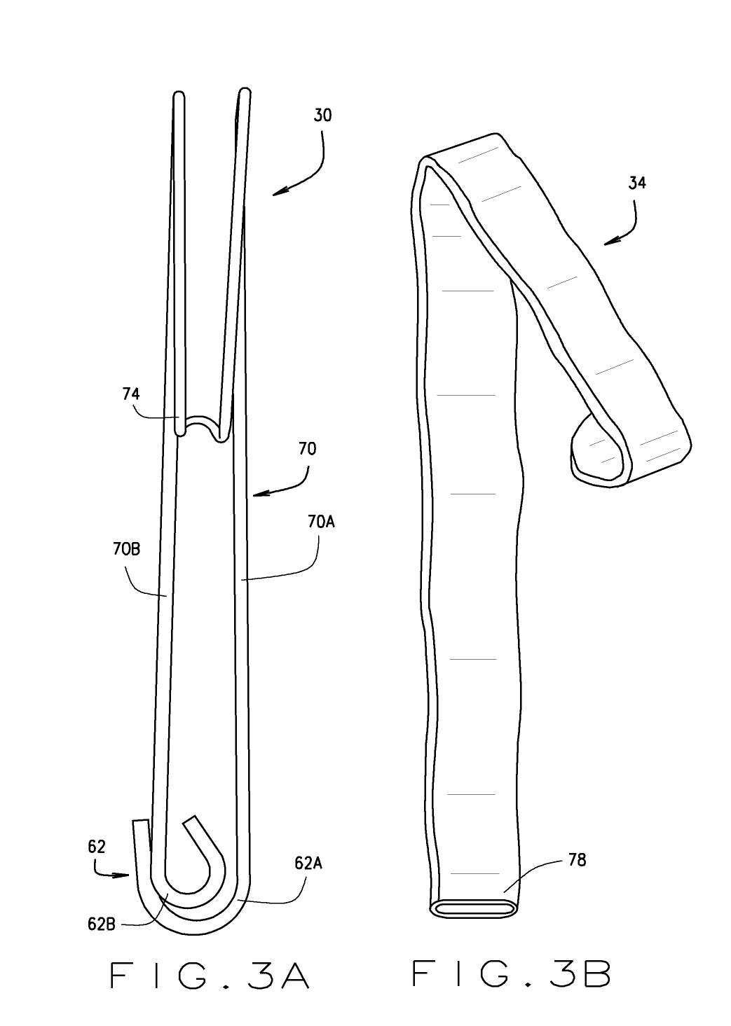

As exemplarily illustrated in FIGS. 3A and 3B, in various embodiments, each clip cover 34 is fabricated from a flexible material and structured as a sock that will fit over the wire frame 70 of a respective belt clip 30. More specifically, in various embodiments, each clip cover 34 is fashioned as a sock that can be removably disposed over the wire frame 70 a respective belt clip 30. Hence, in various embodiments, each clip cover 34 has an open proximal end 78 such that the distal end 74 of a respective wire frame 70 can be inserted into the open proximal end 78, whereafter each clip cover 34 can be ‘fed’ onto the respective belt clip 30, and can be pulled along the wire frame 70 until all, or most of, each wire frame 70 is covered with the respective clip cover 34. It is envisioned that covering each belt clip 30 with a respective clip cover 34 can be done prior to, or subsequent to, connecting each belt clip to the backing panel 22, as described above. Importantly, the material that comprises each clip cover 34 is fabricated to match the material, design and structure of the belt loops 66, as described above. The clip covers 34 can be constructed of any flexible material or fabric, e.g., cotton, denim, rayon, polyester, blends thereof, etc., and have any desired color, pattern or print, suitable for removably installing over a belt clip wire frames 70, as described above, and substantially matching the fabric, material, color, pattern or print of the belt loops 66 of the user's pants 18. Furthermore, and importantly, removability of the clip covers 34 allows clip covers 34 to be interchangeable to match the belt loops 66 of various different pants 18 of the user. That is, clip covers 34 that substantially match the belt loops 66 of a pair of denim jeans can be removed and replaced with clip covers 34 that match the belt loops 66 of a pair of stripped dress slacks. Therefore, the user can remove and replace the clip covers 34 to match the belt loops 66 of whatever pants 18, e.g., jeans, slacks, kakis, shorts, etc. the user selects as the user changes from pair of pants 18 to another.

Referring now to FIG. 2A, in various embodiments, the holster back panel 22 can include a pair of belt apertures 82 structured and operable to receive the user's belt, whereby the holster 10 can be converted from a concealed carry holster for wearing under the user's clothing, as described above, to an exterior holster to be worn on the outside of the user's clothing. More specifically, in such embodiments, the user can select to configure the holster 10 with the belt clips 30 such that he/she can wear the holster 10 and respective firearm 28 in a concealed manner under his/her clothes, as described above, or the user can select to configure the holster 10 without the belt clips 30 to be worn on the exterior of his/her clothes. To configure the holster 10 to be worn on the outside of his/her clothing, the user merely removes the belt clips 30 from the backing plate 22. Particularly, the user simply removes or disengages the clip fasteners 46, e.g., removes the screws 54 and washers 58, from the mounting holes 50, whereby the belt clips 30 can be removed from the backing plate 22. Thereafter, the user can insert his/her belt through the belt loops 66 of his/her pants and additionally through the belt aperture 82 in the backing plate 22, such that the holster 10 is retained on the user's waist exteriorly of his/her clothing.

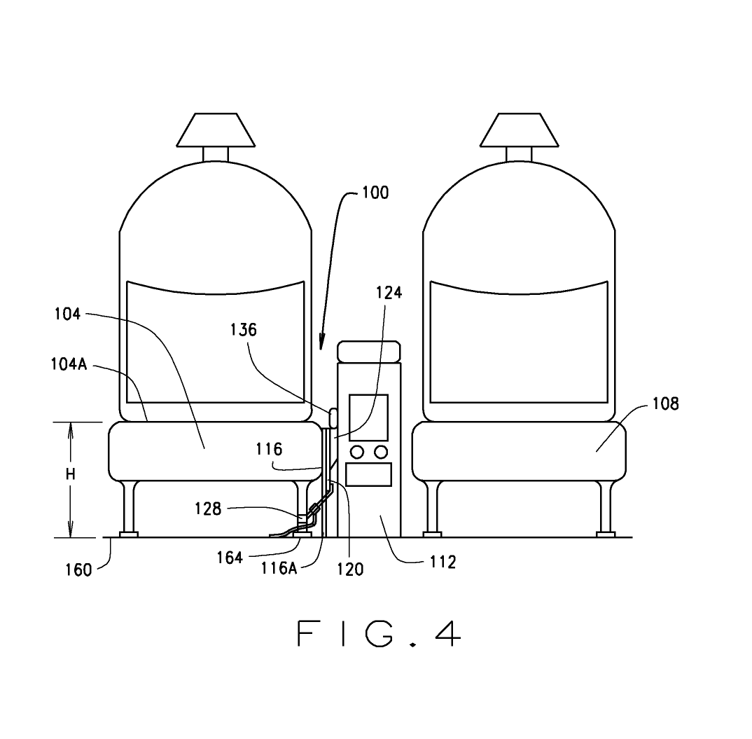

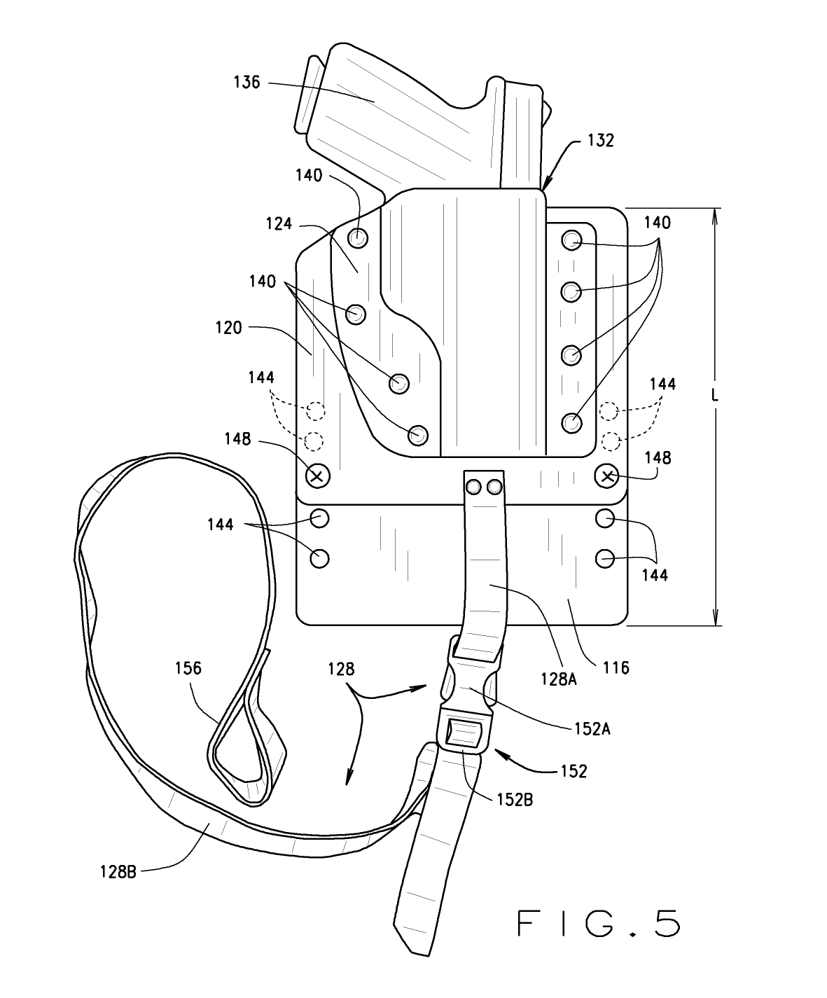

Referring now to FIGS. 4 and 5, in various other embodiments, the present disclosure further provides a concealed-carry firearm holster 100 for use when transporting a firearm in a vehicle, such as a car or truck. The holster 100 is structured and operable to be positioned and secured between two closely adjacent structures of the vehicle. For example, the holster 100 is structured and operable to be positioned and secured between a driver's seat 104 and a center console 110, or a passenger's seat 108 and the center console 112 in vehicles that are equipped with independent driver's and passenger's seats the center console 108. Alternatively, in vehicles that are equipped with a bench seat that is split into a driver's section and a passenger's section, the holster can be structured to be positioned and secured between the driver's and passenger's sections. Although, the bench seat implementation is not illustrated, such an implementation will be easily and readily understood by one skilled in the art.

The holster 100 generally includes a support panel 116 adjustably connected to a backing panel 120, a firearm housing 124 mounted to the backing panel 120, and cinching strap 128 connected to the backing panel 120. The firearm housing 124 is mounted to the backing panel 120 such that the backing panel 120 provides a back side of a firearm 136 receptacle 132 formed between the firearm housing 124 and the backing panel 120. The receptacle 132 is structured and operable to securely, but removably retain a firearm 136, e.g., a pistol. The housing 124 is connected to the backing panel 120 by a plurality of connectors 140 that can be any connecting device suitable to either fixedly or removably connect the housing 26 to the backing panel 120, e.g. screws, rivets, stitching, glue, snaps, etc.

As described above, the backing panel 120 is adjustably connected to the support panel 116. More specifically, disposed along opposing edges, the support panel 116 includes a plurality of adjustment holes 144 through which adjustment fasteners 148 of the backing panel 120 can be inserted and fastened. The adjustment fasteners extend from a back of the backing panel 120 and are insertable through any selected pair of adjustment holes to selectively adjust length L of the holster 100.

The adjustment fasteners 148 can be any fastening device that can be installed, via the selected adjustment holes 144, to securely fasten the backing panel 120 to the support panel 116, and be removed to allow the backing panel 120 to be detached from the support panel 116 then moved to and attached at a different location on the support panel 116, via the adjustment fasteners and holes 148 and 144, in order to adjust the length L for proper installation of the holster 10, as described below. For example, in various embodiments, each adjustment fastener 148 can comprise a nut (not shown) and bolt or screw that are threadably engageable. In such embodiments, the bolts/screws can be either attached to the backing panel 120 or inserted through a pair of apertures in the backing panel 120. To adjust the length L, the nuts are threadingly disengaged from the bolts/screws and the bolts/screws are withdrawn from the respective adjustment holes 148. Subsequently, the bolts/screws are inserted through a different set of adjustment holes such that the length L is equal to a desired length and the nuts are threadingly reengaged with the bolts/screws. Whereafter, the bolts/screws and nuts are tightened to securely connect the backing panel 120 to the support panel 116 such that the length L of the holster 100 is set to the desired length. As described below, the desired length L of the holster 100 is based on a height H of the vehicle seat next to which the holster 100 is to be installed, i.e., the height H of the driver's seat 104 or the passenger's seat 108. Although the holster 100 is exemplarily illustrated having only two adjustment fasteners 148, it is envisioned that the holster 100 can include more than two adjustment fasteners 148 and remain within the scope of the present disclosure.

The cinching strap 128 is a two-part strap comprising a holster section 128A and an anchor section 128B that are detachably connectable with each other via a cinch connector 152. The holster section 128A has a first half 152A of the cinch connector 152 attached at a distal end and is fixedly connected to the backing panel 120 at an opposing proximal end. The anchor section 128B has a second half 152B of the cinch connector 152 adjustably attached at a proximal end and has an anchor loop 156 formed at an opposing distal end. The cinch connector 152 can be any connector suitable to securely connect the holster section 128A of the cinching strap 128 to the anchor section 128B and be structured and operable to allow for adjustment of a length of the cinching strap 128.

For example, in various embodiments, the cinch connector 156 can be a prong-type connector (as exemplarily illustrated in FIG. 4) that includes a pinch-lock for adjusting the length of the cinch strap 128 and pinch-locking the cinch strap 128 at the desired length. In such embodiments, the first half 152A of the cinch connector 152 can comprise a receiving half and be fixedly connected to the distal end of cinch strap holster section 125A, and the second half 152B of the cinch connector 152 can comprise a pronged half that is structured to be inserted into the receiving half to interlockably connect with the receiving half. In various implementations, the pronged half can comprise the pinch-lock. Alternatively, the cinch connector 156 can be a snap, a button, a hook and loop connector, a buckle, Velcro™, etc.

To install the holster 100 in the desired location, e.g., between the driver's seat 104 and the center console 112, a ruler is used to measure the height H of the driver's seat 104. The height H is substantially equal to the distance from a floor 160 of the vehicle and top 104A of the driver's seat 104. Subsequently, the length L of the holster 100 is adjusted, via the adjustment fasteners 148 and adjustment holes 144 as described above, to substantially equal to the height H. Next, the cinching strap holster section 128A is disconnected from the anchor section 128B and the holster 100 is positioned between the driver's seat 104 and the center console 112. The holster 100 is then pushed downward until a bottom edge 116A of the support panel 116 is in firm contact with the floor 160 of the vehicle, thereby providing support for the holster 100 and preventing the holster 100 from sliding further downward between the driver's seat 104 and the center console 112. Once the holster 100 is properly positioned between the driver's seat 104 and the center console 112 with the support panel bottom edge 116A firm in contact with the floor 160 the anchor section 128B of the cinching strap 128 is wrapped around an anchor point 164 of the vehicle.

The anchor point 164 can be any structure of the driver's seat 104 (or the passenger's seat 108 in an alternative installation), or of the center console 112, or any other structure under or near the seat 104 (or seat 108) that is securely attached to the floor 160. For example, in various embodiments, the anchor point 164 can be any portion of the structure connecting the seat 104 or 108 to the floor 160, e.g., the seat track or seat leg. After the cinching strap 128 is wrapped around an anchor point 164 the distal end of the cinching strap anchor section 128B, having the second half 152B of the cinch connected 152 connected thereto, is inserted through the anchor loop 156 and pulled until the cinching strap anchor section 128B is securely tied around or to the anchor point 164. The cinching strap anchor section 128B is then connected to the holster sections 128B via the cinch connector 152. Thereafter, the length of the cinching strap 128 is adjusted, i.e., shortened, via the pinch-lock adjustment of the cinch connector second half 152, to cinch the holster 100 down to the floor 160.

Accordingly, the holster 100 is securely held between the driver's seat 104 and the center console 112 by the cinching strap 128 and will not be pulled from between the driver's seat 104 and the center console 112 when the firearm 136 is removed from the firearm receptacle 132. Furthermore, compressive forces applied to the holster 100 by the driver's seat 104 (or passenger's seat 108) and the center console 112, caused by pushing the holster 100 into the gap between the driver's seat 104 (or passenger's seat 108) and the center console 112, will provide further stability to the positioning of the holster 100 and prevent the holster 100 from easily sliding forward or backward due to forward and backward momentum forces generated during operation of the vehicle.

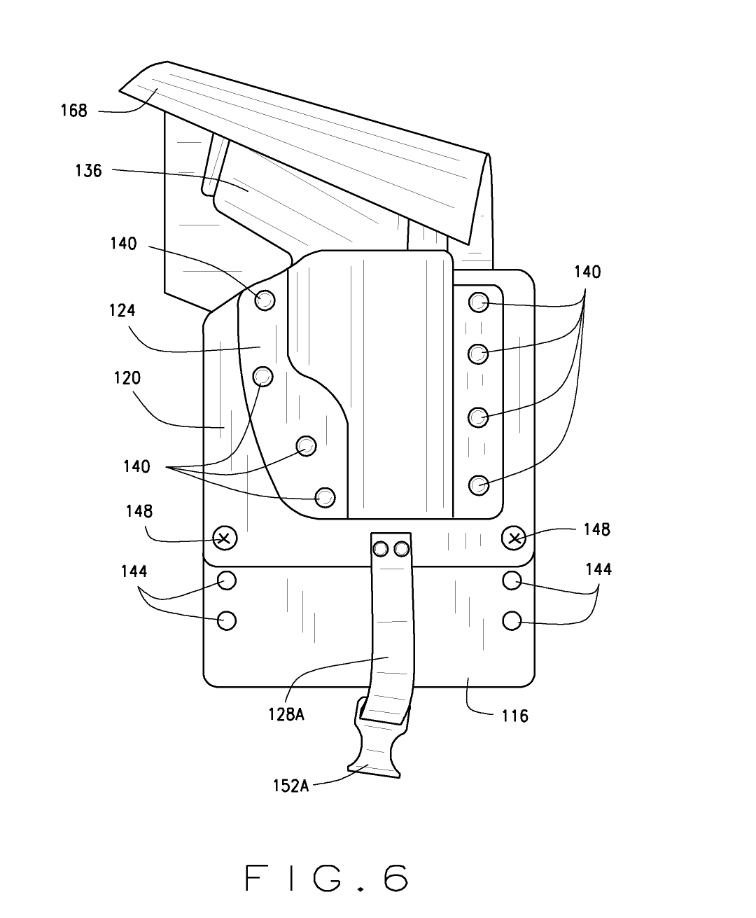

Referring now to FIG. 6, in various embodiments, the holster 100 can further include a concealment flap 168 that can be disposed over the firearm 136 with the firearm is retained within the firearm receptacle 132 and the holster is installed as described above. The concealment flap 168 connected to the support panel 116, e.g., to the back of the support panel 116, and can be any flexible material suitable for laying over the firearm 136 in a blanket or cover-like manner. For example, in various embodiments, the concealment flap 168 can comprise a thin flexible piece of leather suitably sized to cover and conceal the firearm 136 when laid across the firearm 136.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A firearm holster for storing a firearm within a vehicle such that the firearm is secure and easily accessible, said holster comprising
a backing panel;
a firearm housing connected to the backing panel and structured and operable to provide a firearm receptacle to removably retain a firearm;
a support panel connectable to the backing panel, the support panel structured and operable to be positioned and secured, along with the backing panel and firearm receptacle, between two closely adjacent structures of the vehicle and to contact a floor of the vehicle along a bottom edge of the support panel such that the firearm receptacle is positionable at a desired height above the floor between the closely adjacent structures; and
a cinching strap connected to the backing panel, the cinching strap structured and operable to secure the holster to an anchor point within the vehicle.

2. The holster of claim 1, wherein the support panel is adjustably connectable to the backing panel such that a length of the holster can be selectably adjusted, the support panel comprising a plurality of adjustment holes disposed along opposing edges of the support panel, and the backing panel comprising adjustment fasteners that are insertable through selected adjustment holes to fasten the backing panel to the support panel such that the holster has a selected length.

3. The holster of claim 1, wherein the cinching strap comprises a holster section and an anchor section, the holster section fixedly connected at a proximal end to the backing panel and removably connectable to the anchor section via a cinch connector.

4. The holster of claim 3, wherein the cinch connector comprises:
a first half connected to a distal end of the holster section of the cinch strap; and
a second half removably connectable with the cinch connector first half and connected to a proximal end of the anchor section of the cinch strap.

5. The holster of claim 4, wherein the anchor section of the cinch strap comprises an anchor loop, the anchor loop structured and operable to have the proximal end of the anchor section, including the cinch connector second half, inserted therethrough after the anchor section has been wrapped around an anchor point of the vehicle such that the anchor section is secured to the anchor point.

6. The holster of claim 5, wherein the second half of the cinch connector is adjustably connected to the proximal end of the anchor section such that, after the anchor section has been secured to the anchor point, the anchor section can be connected to the holster section, via the cinch connector, and the length of the cinch strap can be adjusted to cinch the holster to the anchor point, thereby securing the holster to the anchor point and between the closely adjacent structures.

7. The holster of claim 1, further comprising a concealment flap connected to the support panel such that the concealment flap can be disposed over a firearm retained within the firearm receptacle to conceal the firearm.

8. A firearm holster for storing a firearm within a vehicle such that the firearm is secure and easily accessible, said holster comprising
a backing panel;
a firearm housing connected to the backing panel and structured and operable to provide a firearm receptacle to removably retain a firearm;
a support panel adjustably connectable to the backing panel such that a length of the holster can be selectably adjusted, the support panel comprising a plurality of adjustment holes disposed along opposing edges of the support panel, and the backing panel comprising adjustment fasteners that are insertable through selected adjustment holes to fasten the backing panel to the support panel such that the holster has a selected length, the support panel structured and operable to be positioned and secured, along with the backing panel and firearm receptacle, between two closely adjacent structures of the vehicle and to contact a floor of the vehicle along a bottom edge of the support panel such that the selected length of the holster positions the firearm receptacle at a desired height above the floor between the closely adjacent structures; and
a cinching strap connected to the backing panel, the cinching strap structured and operable to secure the holster to an anchor point within the vehicle.

9. The holster of claim 8, wherein the cinching strap comprises a holster section and an anchor section, the holster section fixedly connected at a proximal end to the backing panel and removably connectable to the anchor section via a cinch connector.

10. The holster of claim 9, wherein the cinch connector comprises:
a first half connected to a distal end of the holster section of the cinch strap; and
a second half removably connectable with the cinch connector first half and connected to a proximal end of the anchor section of the cinch strap.

11. The holster of claim 10, wherein the anchor section of the cinch strap comprises an anchor loop, the anchor loop structured and operable to have the proximal end of the anchor section, including the cinch connector second half, inserted therethrough after the anchor section has been wrapped around an anchor point of the vehicle such that the anchor section is secured to the anchor point.

12. The holster of claim 11, wherein the second half of the cinch connector is adjustably connected to the proximal end of the anchor section such that, after the anchor section has been secured to the anchor point, the anchor section can be connected to the holster section, via the cinch connector, and the length of the cinch strap can be adjusted to cinch the holster to the anchor point, thereby securing the holster to the anchor point and between the closely adjacent structures.

13. The holster of claim 8, further comprising a concealment flap connected to the support panel such that the concealment flap can be disposed over a firearm retained within the firearm receptacle to conceal the firearm.

14. A firearm holster for storing a firearm within a vehicle such that the firearm is secure and easily accessible, said holster comprising
a backing panel;
a firearm housing connected to the backing panel and structured and operable to provide a firearm receptacle to removably retain a firearm;
a support panel connectable to the backing panel, the support panel structured and operable to be positioned and secured, along with the backing panel and firearm receptacle, between two closely adjacent structures of the vehicle and to contact a floor of the vehicle along a bottom edge of the support panel such that the firearm receptacle is positionable at a desired height above the floor between the closely adjacent structures;
a cinching strap connected to the backing panel, the cinching strap structured and operable to secure the holster to an anchor point within the vehicle; and
a concealment flap connected to the support panel such that the concealment flap can be disposed over a firearm retained within the firearm receptacle to conceal the firearm.

15. The holster of claim 14, wherein the support panel is adjustably connectable to the backing panel such that a length of the holster can be selectably adjusted, the support panel comprising a plurality of adjustment holes disposed along opposing edges of the support panel, and the backing panel comprising adjustment fasteners that are insertable through selected adjustment holes to fasten the backing panel to the support panel such that the holster has a selected length.

16. The holster of claim 14, wherein the cinching strap comprises a holster section and an anchor section, the holster section fixedly connected at a proximal end to the backing panel and removably connectable to the anchor section via a cinch connector.

17. The holster of claim 16, wherein the cinch connector comprises:
a first half connected to a distal end of the holster section of the cinch strap; and
a second half removably connectable with the cinch connector first half and connected to a proximal end of the anchor section of the cinch strap.

18. The holster of claim 17, wherein the anchor section of the cinch strap comprises an anchor loop, the anchor loop structured and operable to have the proximal end of the anchor section, including the cinch connector second half, inserted therethrough after the anchor section has been wrapped around an anchor point of the vehicle such that the anchor section is secured to the anchor point.

19. The holster of claim 18, wherein the second half of the cinch connector is adjustably connected to the proximal end of the anchor section such that, after the anchor section has been secured to the anchor point, the anchor section can be connected to the holster section, via the cinch connector, and the length of the cinch strap can be adjusted to cinch the holster to the anchor point, thereby securing the holster to the anchor point and between the closely adjacent structures.
